(19) United States
(12) Patent Application Publication
(10) Pub. No.: US 2013/0028054 A1
(43) Pub. Date: Jan. 31, 2013

(54) Ultrasonic membrane

(71) Applicant: Ian Alistair Ritchie, Totnes (GB)

(72) Inventor: Ian Alistair Ritchie, Totnes (GB)

(21) Appl. No.: 13/270,556

(22) Filed: Oct. 11, 2011

(30) Foreign Application Priority Data
Apr. 7, 2010 (GB) 1005787.5

(51) Int. Cl. H04B 1/02

(52) U.S. Cl. 367/137

(57) ABSTRACT

An ultrasonic membrane having ultrasonic transmission(s) over the surface area of the membrane with circuitry to control transmission(s), it can be made to any size but can also be connected to other membranes in each direction to cover large areas for example a super tanker hull.

### THE FIELD OF THE INVENTION

The present invention relates to apparatus for anti-fouling boat hulls.

### BACKGROUND TO THE INVENTION

The invention relates to reducing or eliminating marine growth on a ship's hull and other marine craft. Marine growth on a ship's hull reduces the ability of the ship to move through the water and thereby increases the amount of power required to propel the ship. This has an enormous cost implication in extra fuel required together with the subsequent extra greenhouse gases that are produced.

It is known that ultrasound can have an anti-fouling effect on boat hulls by inhibiting the growth of marine algae and other marine life that adheres to boat hulls and therefore reducing or negating the need to use anti-fouling paints.

Currently the ultrasound systems used use individual transducers with a diameter of approximately 3 inches. The transducers send out high levels of ultrasound to have an impact on all or most of a comparatively small boat e.g. 36 ft. The problem with this is that high levels of ultrasound are used with a sledge hammer type approach with little regard to the impact on marine life or possible implications for people onboard the boat.

The other approach is to cover the hull with anti-fouling paint which has extensive cost implications and can have toxicity considerations. Major shipping companies entail significant cost in dry docking and paint application. Increasing restrictions on where and what can be used or disposed of further exacerbate the problem.

### THE INVENTION

The object of the present invention is to provide apparatus having a “localized” anti-fouling effect on marine growth but also capable of covering the entire hull of all ships whatever the size. This allows the use of the minimum amount of power to be used in any one area and frequency and amplitude of the ultrasound can be controlled over the entire hull.

According to the invention there is provided an ultrasonic apparatus for creating an anti-fouling effect for marine craft and structures, the apparatus comprising:

An ultrasonic membrane containing numerous transducers having an ultrasonic effect over the entire surface of the membrane,

Circuitry for controlling transmission from the transducers incorporated in the membrane.

The Invention is a membrane with a multitude of transducers allowing for an ultrasonic acoustic effect over the area of the membrane. Depending on the design and components of the membrane the total membrane could be a multiple of transducers, incorporated with acoustic strips and or other shapes, matrix of transducers or with characteristics operating like a transducer or incorporating one very large panel with acoustic properties. Each membrane can be attached to other membranes in all directions creating a set of membranes that can be “wall papered” onto a ship's hull or other marine craft or structure.

The primary application for the membrane is for super tankers and other shipping, marine craft and marine structures. The invention reduces operating costs and greenhouse gases by acting in an “anti-fouling mode of operation”. (Research has shown that ultrasound can prevent marine growth together with having anti-bactericidal effects at certain amplitudes and frequencies).

### THE DRAWINGS

To help understanding of the invention, a specific embodiment thereof will now be described by way of example and with reference to the accompanying drawings, in which:

FIG. 1 is a diagrammatic view of ultrasonic membrane apparatus of the invention from above.

FIG. 2 is a similar view of membrane in 3D

FIG. 3 is a view of the electrical contacts to the transducers in the membrane and other membranes.

FIG. 4 is a view of the transducers sitting on a base plate.

FIG. 5 is a view of the membrane(s) attached to the hull of a ship

FIG. 6 is a view of the membrane(s) attached to the hull viewed from the front of the ship.

FIG. 7 is a view of the membrane(s) attached to the inside of a pipe.

FIG. 8 is a view of the membrane(s) attached to the inside of a tank.

FIG. 9 is an air vent with membrane(s) incorporated within the vent.

### PREFERRED EMBODIMENT

The structure shown in the drawings has transducers configured within a membrane forming an ultrasonic membrane that can be attached to adjoining membranes.

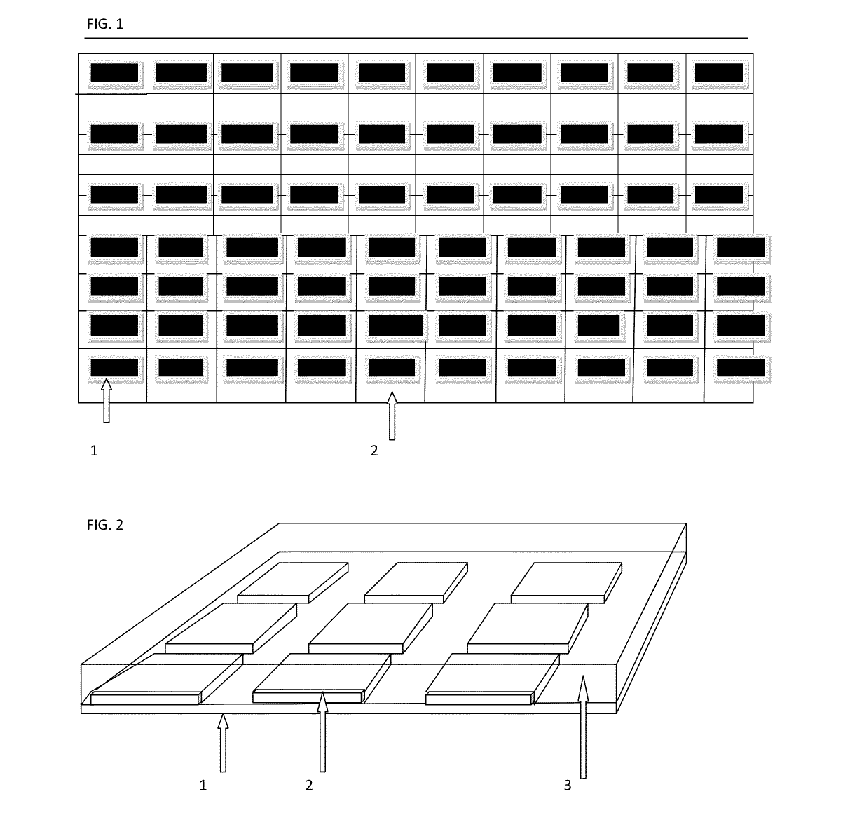

FIG. 1 shows the transducers 1. spread throughout the membrane 2.

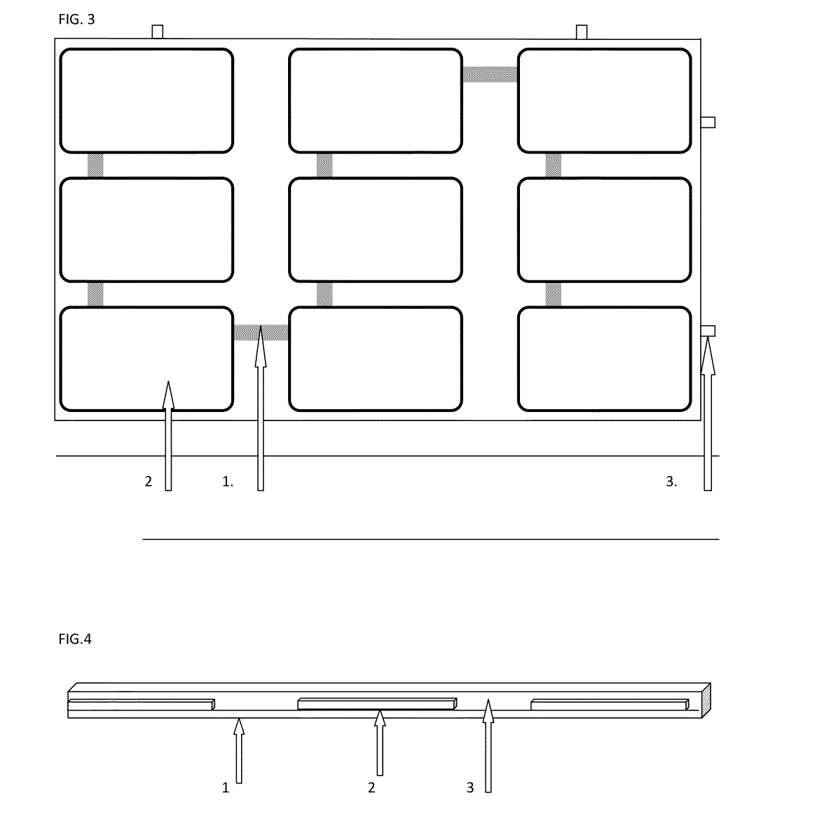

FIG. 2 shows a 3D image of the transducers 2. located within the membrane and sitting on a base 1. and retained in position with resin 3.

FIG. 3 shows the electrical connections 1. between the transducers 2. and also connection between interconnecting membranes 3.

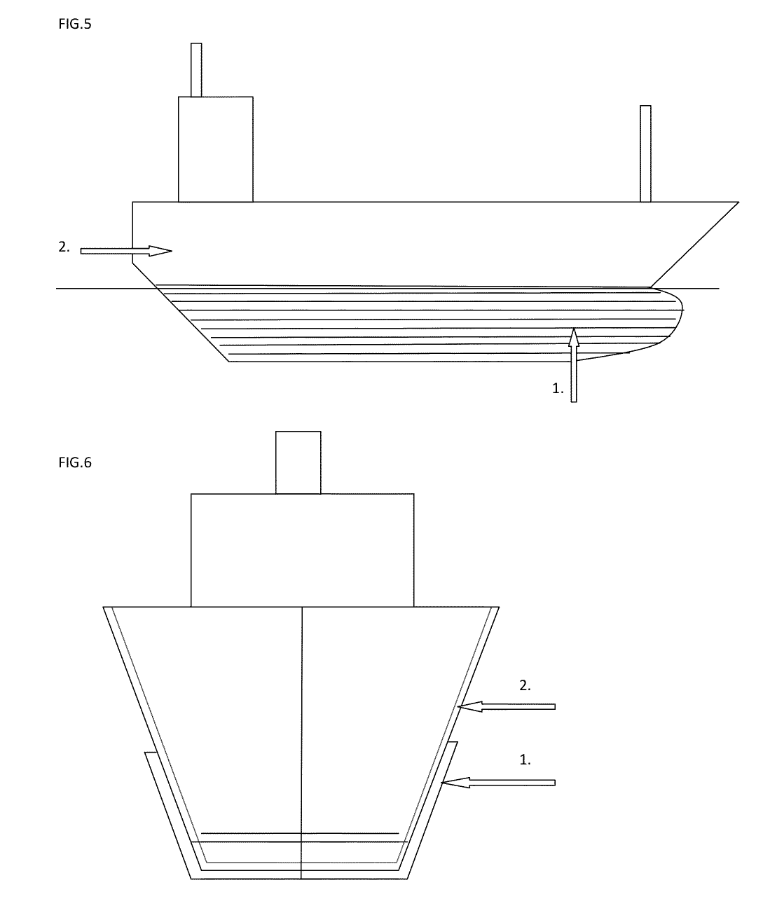

FIG. 4 shows the base 1. the transducers 2. And resin 3. from the side view.

FIG. 5 shows the membrane(s) 1. covering the hull of a ship 2. up to the water line.

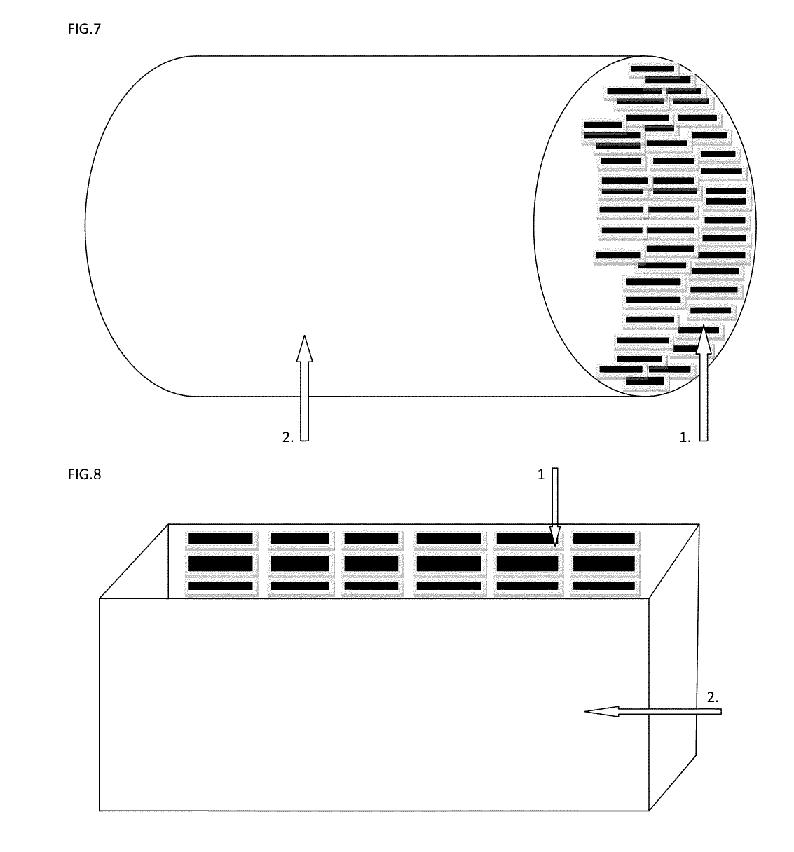

FIG. 6 shows the membrane(s) 1. attached to the hull 2. viewed from the front.

FIG. 7 shows the membrane(s) 1. connected to the inside of a pipe 2.

FIG. 8 shows the membrane(s) 1. connected to the inside of a tank 2.

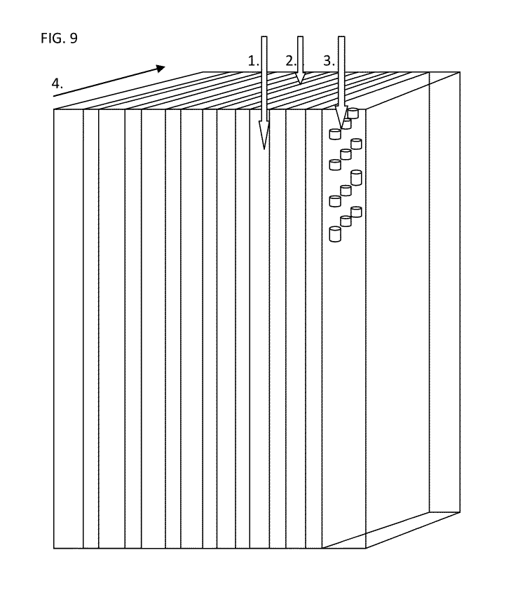

FIG. 9 shows an air vent 1. membrane(s) 2. transducer(s) within membrane 3. air flow direction 4.

We claim:

1. An ultrasonic membrane producing an ultrasonic transmission over the surface area of the membrane, can be made to any size but can also be interconnected to adjoining membrane(s) allowing substantial coverage and connects to circuitry for controlling transmission(s).

2. An ultrasonic membrane as claimed in claim 1, having an electrically conductive base panel.

3. An ultrasonic membrane as claimed in claim 1, having an ultrasonically conductive top panel.

4. An ultrasonic membrane as claimed in claim 1, having the transducers contained within resin or other mediums.

5. An ultrasonic membrane as claimed in claim 1, having EMAT circuitry allowing Electro Magnetic capabilities for assisting ultrasonic emissions through paint, rust, fiberglass and other covering materials.

6. An ultrasonic membrane as claimed in claim 1, having a single transducer creating a transmission throughout the area of the membrane or part thereof.

7. An ultrasonic membrane as claimed in claim 1, covering the internal surfaces of tanks containing liquids and other materials.

8. An ultrasonic membrane as claimed in claim 1, covering the internal surface of pipes.

9. An ultrasonic membrane as claimed in claim 1, located on the internal surface of a hull with the ultrasound emission going through the hull.

10. An ultrasonic membrane as claimed in claim 1, sandwiched within the structure of the hull, for example sandwiched within a fiberglass hull, with emissions travelling through the hull.

11. An ultrasonic membrane as claimed in claim 1, located on the outside surface of containers including tanks and pipes and the ultrasonic emission penetrating such containers/pipes and coming into contact with the contents of the container/pipe.

12. An ultrasonic membrane as claimed in claim 1, located within the walls of containers or pipes with emission entering the container or pipe.

13. An ultrasonic membrane as claimed in claim 1, located on surfaces to eliminate bacteria, viruses and other forms of contamination.

14. An ultrasonic membrane as claimed in claim 1, located below or behind surfaces to eliminate: bacteria, viruses, and other forms of contamination on those surfaces.

15. An ultrasonic membrane as claimed in claim 1, located on the surface, internally to the surface or behind the surface of any structure to generate ultrasonic transmissions.

16. An ultrasonic membrane as claimed in claim 1, generating an ultrasonic effect on a liquid or substance to modify the characteristics of the liquid or substance.

17. An ultrasonic membrane as claimed in claim 1, generating a multi-gated ultrasonic transmission into a liquid or substance to analyze the characteristics of the liquid or substance at different depths (e.g. flow rates or density).

18. An ultrasonic membrane as claimed in claim 1, generating a 2 or 3 dimensional image(s).

19. An ultrasonic membrane as claimed in claim 1, generating N.D.T. (Non Destructive Transducer) diagnostic capabilities e.g. steel thickness and steel patency.

20. An ultrasonic membrane as claimed in claim 1, detecting temperature changes in various or all areas of the membrane or areas that the ultrasonic emissions of the membrane or the membrane come in contact with.

21. An ultrasonic membrane as claimed in claim 1, having an effect on airborne organisms such as bacteria and viruses

22. An ultrasonic membrane as claimed in claim 1, made out of a fabric or metal based material.

23. An ultrasonic membrane as claimed in claim 1. made out of or incorporating carbon fiber.

24. An ultrasonic membrane as claimed in claim 1. consisting of plastic(s) type materials.

25. An ultrasonic membrane as claimed in claim 1. incorporating rubber based materials.

26. An ultrasonic membrane as claimed in claim 1. acting as an acoustic panel.

27. An ultrasonic membrane as claimed in claim 1. incorporated into any system for cleaning, disinfecting, analyzing or modifying: water, solutions, air, gases, substances, materials or structures.

28. An ultrasonic membrane as claimed in claim 1. positioned on, within or part of the structure of tanks and pipes, to destroy algae and other contaminants found in diesel fuel and other fuels.

29. An ultrasonic membrane as claimed in claim 1. with ultrasonic transmissions over the surface area(s) of the membrane and surrounding area(s).
